(19) United States
(12) Patent Application Publication
(10) Pub. No.: US 2026/0346431 A1
(43) Pub. Date: Nov. 5, 2026

(54) EXTENDIBLE MECHANICAL ARM ASSEMBLY

(71) Applicant: BionicHIVE Ltd.

(72) Inventors: Liran RAIZER, Ein HaBsor (IL); Ofer BEN-BASSAT, Ashdod (IL)

(21) Appl. No.: 18/997,703

(22) PCT Filed: Jun. 15, 2023
(86) PCT No.: PCT/IL2023/050622

§ 371 Date: Jan. 22, 2025

Related U.S. Application Data
(60) Provisional application No. 63/369,382, filed on Jul. 26, 2022.

(51) Int. Cl. B25J 9/10; B25J 18/02

(52) U.S. Cl. CPC B25J 9/104; B25J 18/02

(57) ABSTRACT

Disclosed herein is an extendible mechanical arm assembly. The extendible mechanical arm assembly comprises: an arm, comprised of a strip of resilient metal, and a drum sub-assembly comprising a drum and a reversible motor. The arm has a first end that is attached to the drum and a second end. The reversible motor is configured to rotate the drum in one direction to wind the arm around the drum thereby retracting the arm towards the drum sub-assembly, and the reversible motor is configured to rotate the drum in a second, opposite direction thereby unwinding the arm from the drum and extending the second end of the arm away from the drum sub-assembly. Also disclosed are embodiments that comprise two or more of the arm assemblies.

### FIELD OF THE INVENTION

The invention is from the field of mechanics. Specifically the invention relates to the design and function of a mechanical arm on a drum sub-assembly that is configured to extend and retract the mechanical arm in order to move objects attached to the arm.

### BACKGROUND OF THE INVENTION

Mechanical arms of many types are designed to assist in carrying out a wide range of tasks from delicate surgery to relatively simple jobs such as moving items in factories. Mechanical arms on robotic devices are essential in modern industrial facilities such as vehicle and semiconductor plants. A search in Google for the search term “robotic arm” returns over 48 million results and a search in the USPTO database for the same search term returns over 20,000 results. These are indications of the large number of different designs of robotic arms that have been invented and the uses that have been found for them.

Mechanical arms are typically comprised of a number of rigid links that are connected by rotational or linear actuators to allow one, two, or three dimensional movements of the arm and in some embodiments also one, two or three rotational movements of the end effector at the distal end of the arm. Most industrial robotic arms are activated by programmable control systems. Advanced systems use machine vision and/or machine learning to carry out their tasks and improve performance.

An example of the use of a robotic arm is presented in U.S. Pat. No. 10,259,649 to the inventor of the present application. In this patent is described an automatic system for picking and placing boxes or objects on shelves in warehouses. The system is based on the use of a plurality of autonomous robots that are configured to navigate to and from locations on the shelving system of the warehouse. In order to pick and place boxes on the shelves the robots are equipped with a gripper mechanism configured to pull, push, and lift the boxes and move them to the shelf from the robot and vice versa.

Since common warehouse racks are built to accommodate pallets that are one or more meters wide, the autonomous robots in the system described in U.S. Pat. No. 10,259,649 must comprise robotic arms capable of reaching at least one meter. Similar autonomous robots can be used in other applications, for instance, to pick and place boxes or items in shipping containers or delivery trucks, in which cases the robotic arms may have to reach even further distances. Because of the limited space for maneuvering in the locations in which these robots operate, e.g. the distance between warehouse racks, in order to be able to achieve the required distances a rigid arm cannot be used and what is required is a compact arm assembly that comprises an extendible arm.

It is a purpose of the present invention to provide a compact mechanical arm system comprising an arm configured to be extended and retracted to move an object to or from any predetermined maximum distance from a base on which the system is mounted.

It is another purpose of the present invention to provide a compact mechanical arm system configured to extend and retract an arm to pick and place an item at any distance up to a predetermined maximum from a base on which the system is mounted.

Further purposes and advantages of this invention will appear as the description proceeds.

### SUMMARY OF THE INVENTION

Disclosed herein is an extendible mechanical arm assembly. The extendible mechanical arm assembly comprises: an arm, comprised of a strip of resilient metal, and a drum sub-assembly comprising a drum and a reversible motor. The arm has a first end that is attached to the drum and a second end. The reversible motor is configured to rotate the drum in one direction to wind the arm around the drum thereby retracting the arm towards the drum sub-assembly, and the reversible motor is configured to rotate the drum in a second, opposite direction thereby unwinding the arm from the drum and extending the second end of the arm away from the drum sub-assembly.

In embodiments of the extendible mechanical arm assembly the arm comprises an end effector attached to the second end of the arm. The end effector is configured to allow mounting at the end of the arm any tools that are required for allowing a system to which the extendible mechanical arm assembly is attached to carry out its assigned task. In these embodiments, the tools can be one or more of: cameras, suction grippers, mechanical grippers, wrenches, lasers, ultrasound transducers, and barcode or QR code readers.

In embodiments of the extendible mechanical arm assembly the drum sub-assembly can be mounted on a stationary or mobile platform of any type of mechanical system that requires the use of an extendable arm. In these embodiments the mechanical system can be one of: a stationary robot, a mobile robot, and an autonomous mobile robot.

In embodiments of the extendible mechanical arm assembly the drum sub-assembly is mounted on a base, which is configured to elevate, tilt, or rotate the drum sub-assembly, thereby allowing the end effector to be moved to and between any desired locations in three dimensional space around the drum sub-assembly within a maximum radius determined by the length of arm.

In embodiments of the extendible mechanical arm assembly the arm is comprised of a strip of high yield spring steel.

In embodiments of the extendible mechanical arm assembly the arm in its extended state has a concave cross section. In these embodiments the cross section of the arm is forced to be flat when it is wound onto the drum and the material of which the arm is made is resilient enabling the cross section to return to its concave shape when the arm is unwound from the drum and returned to its extended state.

In embodiments of the extendible mechanical arm assembly components of the drum sub-assembly are enclosed in and supported by a framework. In these embodiments the framework comprises at least two walls facing each other on opposite sides of the drum sub-assembly.

In embodiments of the extendible mechanical arm assembly the reversible electric motor is one of:
a) an external motor that transfers force from an output shaft of the motor to an axle of the drum by means of a mechanical connection: and
b) a frameless electric motor, wherein the stator of the frameless motor, which is fixed to the walls of the framework of the drum sub-assembly, is comprised of a motor core around which are windings of the motor and motor poles of the permanent magnets and the drum acts as the rotor of the motor, which revolves around the stator.

In embodiments of the extendible mechanical arm assembly the drum sub-assembly comprises a support roller configured to support and guide the arm as it is coiled onto and uncoiled from the drum.

In embodiments of the extendible mechanical arm assembly the drum sub-assembly comprises several roller assemblies configured to keep incoming and outgoing portions of the arm firmly pressed against other portions of the arm that are coiled on the drum as the arm is retracted or extended. These embodiments of the roller assemblies can comprises a shaft that is attached to the frame so that the shaft cannot rotate and several spaced apart rollers are attached to the shaft via ball bearings. These embodiments of the roller assemblies can comprises a spring stretched over both ends of the shafts of the roller sub-assemblies on the outside of the walls of the framework; wherein the spring is configured to exert a force that pushes the roller sub-assemblies towards the center of the drum.

Embodiments of the extendible mechanical arm assembly comprise two drum sub-assemblies and associated arms. The two drum sub-assemblies are mounted one above the other between the walls of the framework and the ends of both arms are attached to a common end effector. These embodiments of the extendible mechanical arm assembly comprise a shaping roller between the support rollers and drums of the two drum sub-assemblies. The shaping roller is configured to support the natural concave shape of the arms, to create tension against the support rollers and make the arms more rigid and to vibrate less. In these embodiments in the extended states of the arms, the concave surfaces of both arms are oriented in one of the following ways:
a) facing in an upwards direction; thereby creating a beam-like structure for moving items horizontally; and
b) facing each other; thereby creating a beam-like structure suitable for moving items vertically.

In embodiments of the extendible mechanical arm assembly comprising two drum sub-assemblies and associated arms the angle of the end effector relative to the front of the drum sub-assembly is changed by activating the two arm assemblies to unwind different lengths of respective arms.

Embodiments of the extendible mechanical arm assembly comprise a cable, a cable drum, an extendible cable post, and a cable post height adjustment mechanism; wherein:
a) a first end of the cable is attached to the cable drum and a second end of the cable is attached to an end effector at the second end of the arm;
b) the cable drum is mounted at the top of the cable post;
c) the cable post projects out of the top of the drum sub-assembly;
d) the height of the cable post is changed by activation of a cable post height adjustment mechanism;
e) the length of the cable unwound from or wound back onto the drum is changed as the arm is extended of retracted;
f) the cable post height adjustment mechanism comprises a belt which transfers rotation of a first pulley on the output shaft of the electric motor to the rotation of a second pulley on an axle of the drum of the drum sub-assembly and a third pulley on an input shaft to the cable post height adjustment mechanism, thereby changing the height of the cable post in synchronization with changes in the length of the arm; and
g) springs on both sides of cable drum configured to provide tension on the cable. thereby allowing it to be unwound from cable drum as the arm is extended and to wind the cable back onto the cable drum as the arm is pulled back into the drum sub-assembly. the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows the robotic arm assembly of the invention;

FIG. 2 schematically shows the arm of the assembly of FIG. 1;

FIG. 3 schematically shows the drum sub-assembly;

FIG. 4 schematically shows main components of the drum sub-assembly;

FIG. 5 symbolical shows a cross section of a frameless electric motor;

FIGS. 6a and 6b schematically show springs configured to prevent backlash when the arm is wound onto the drum or unwound from it;

FIG. 7a shows the basic construction of an embodiment of an arm assembly;

FIG. 7b illustrates how the embodiment of FIG. 7a can be activated to change the angle of the end effector;

FIG. 8 shows an embodiment of an arm assembly configured to raise or lower an object attached to its end effector vertically;

FIGS. 9a and 9b schematically show an embodiment of an arm assembly, which provides support to resist bending of the arm, provide rigidity, and eliminate vibrations; and

FIGS. 10a to 10d are photographs showing a scenario in which the arm assembly described herein is employed.

### DETAILED DESCRIPTION OF EMBODIMENTS OF THE INVENTION

Presented herein is an extendible mechanical arm assembly. The mechanical arm assembly comprises an arm comprised of a strip of resilient metal. The arm is attached at one of its ends to a drum and, in embodiments, has an end effector attached to the other end. A reversible motor is configured to rotate the drum to retract the arm by winding it around the drum or to extend the arm by unwinding it from the drum.

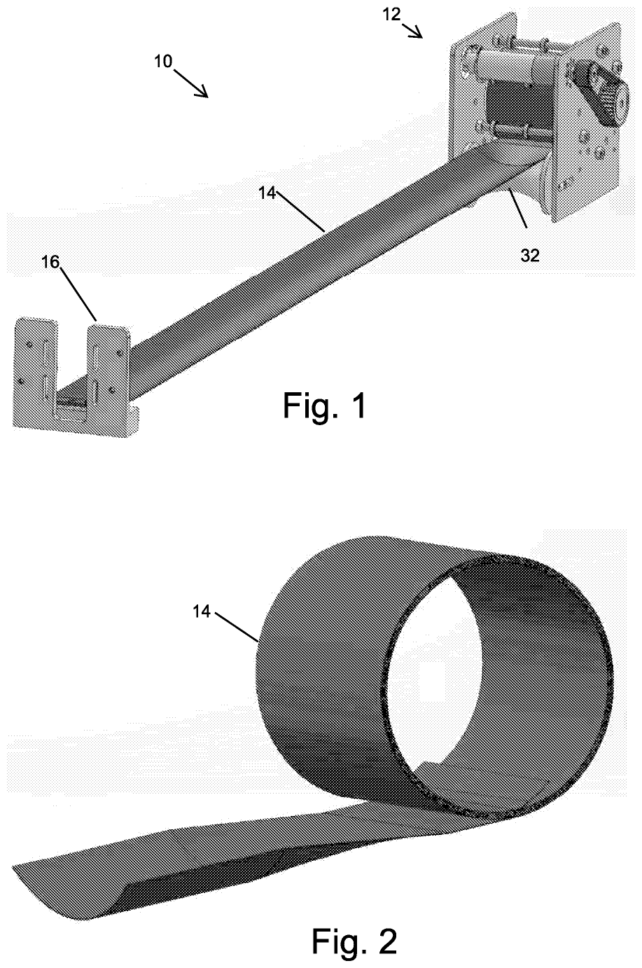

FIG. 1 schematically shows the mechanical arm assembly 10 of the invention. Mechanical arm assembly 10 comprises: drum sub-assembly 12, arm 14, and end effector 16. In this figure arm 14 is shown extended away from the drum sub-assembly 12. Shown at the bottom of the drum sub-assembly 12 is a support roller 32, which is configured to support and help transition arm 14 from a configuration having a flat cross section when rolled on the drum to a configuration having a concave configuration when it is extended.

The end effector 16 is configured to allow mounting at the end of the arm 14 any tools that are required for allowing a system to which the arm is attached to carry out its assigned task. These tools can include, for examples, cameras, suction or mechanical grippers, wrenches, lasers, ultrasound transducers, and barcode or QR code readers.

The arm assembly 10 can be used in connection with any type of mechanical system that requires the use of an extendable arm. Mechanical arm assembly 10 can be mounted on a stationary or mobile platform. Illustrative but non-limiting examples are robotic systems used on assembly lines in factories and surgical robotic systems, and mobile robots, e.g. those programmed to act as waiters in restaurants. Mechanical arm assembly 10 can be mounted on autonomous robots such as those described in the above referenced U.S. Pat. No. 10,259,649.

The arm 14 can be extended or retracted only in one direction, i.e. perpendicular to drum sub-assembly 12. However, drum sub-assembly 12 can be mounted on a base, which (depending on the task the arm assembly 10 is required to perform) is configured to elevate, tilt, or rotate drum sub-assembly 12 and therefore to allow end effector 16 to be moved to and between any desired locations in three dimensional space around drum sub-assembly 12 within a maximum radius determined by the length of arm 12. Descriptions of suitable bases and their control systems are not included herein since they are not relevant to the present invention.

FIG. 2 schematically shows the arm 14 of the arm assembly 10. In its extended state the upwards facing surface of arm 14 is concave as shown in FIG. 2. The concave cross section provides arm 14 with several orders of magnitude more rigidity then a flat cross section, thereby preventing arm 14 from bending downwards as it is extended. As a non-limiting example, if an arm having a flat cross section can support a maximum weight of 10 grams, then an arm having a concave cross section that is made of the same material and has the same length can support 10 Kg. As will be described below, the cross section of arm 14 is forced to be flat as it is wound into a tight coil when withdrawn onto drum 20; but the material of which arm 14 is made is resilient enough that the cross section returns to its concave shape when arm 14 is unwound and returns to its extended state.

In an embodiment arm 14 is comprised of a strip of high yield spring steel and in other embodiments could be made from polymer or elastomeric material. Examples of types of steel that are suitable for arm 14 are: C75S, SAE 1070, SAE 1095, and AISI 302.

The weight that arm 14 can support depends on the material and specific geometry of the arm. Two specific examples that have been tested are:
1) Material: C75S; Geometry: 100 mm width, 0.4 mm thickness, 71 mm radius, length 1.2 m; Results: about 1.5 kgf weight support and above 20 kgf of compression/tension.
2) Material: C75S; Geometry: 100 mm width, 0.5 mm thickness, 117 mm radius, length 1.2 m; Results: about 1.3 kgf weight support and above 20 kgf of compression/tension.

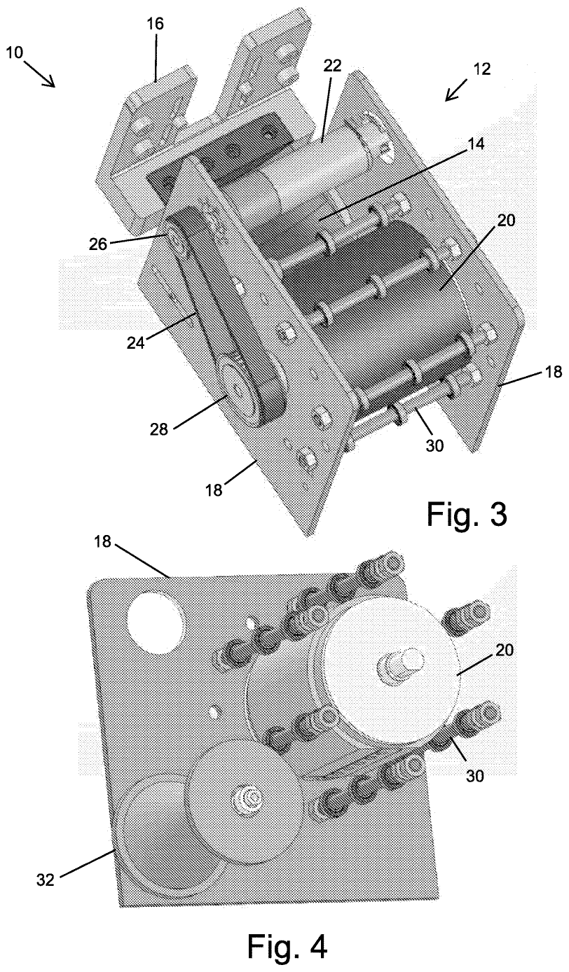

FIG. 3 schematically shows a view of mechanical arm assembly 10 with the arm 14 withdrawn into the drum sub-assembly 12. FIG. 4 schematically shows the components of the drum sub-assembly 12 that act to coil the arm 14 onto drum 20. The components of drum sub-assembly 12 are enclosed in and supported by a framework of which two walls 18 are shown in FIG. 3 and one wall has been removed in FIG. 4.

One end of arm 14 is permanently joined to drum 20. In order to extend or retract arm 14, a reversible electric motor 22 exerts a force to rotate drum 20. In the embodiment shown in FIGS. 1 and 3, motor 22 is an external motor that transfers force to the drum 20 by means of a mechanical connection, which in the embodiment shown is a first pulley 26 on the output shaft of motor 22, a second pulley 28 on an axle of drum 20, and belt 24.

To rewind arm 14 onto drum 20 motor 22 rotates the drum 20 to retract the arm 14 by winding arm 14 onto the drum 20, concave support roller 32 (see FIG. 1) supports and guides arm 14 as it enters drum sub-assembly 12. As the drum 20 turns and arm 14 is pulled into the bottom of drum sub-assembly 12 and coiled around drum 20, the cross section of arm 14 flattens and incoming portions of the arm 14 are kept pressed against previous coils by several roller sub-assemblies 30.

To unwind arm 14 from drum 20 and extend it the opposite process takes place. That is, as motor 22 rotates the drum 20 arm 14 is uncoiled from around drum 20 and passes out of drum sub-assembly 12 over concave support roller 32, which supports and guides arm 14. As it exits drum sub-assembly 12 the cross section of arm 14 resumes its concave shape.

Each of the roller sub-assemblies 30 is comprised of a shaft that is attached to walls 18 so that it cannot rotate. Several spaced apart rollers are attached to each shaft via ball bearings. In the embodiment shown there are six roller sub-assemblies 30 each one comprising three rollers spaced about the drum 20; however other embodiments of the drum sub-assembly 12 can comprise more or less than six roller sub-assemblies 30, each comprising more or less than three rollers.

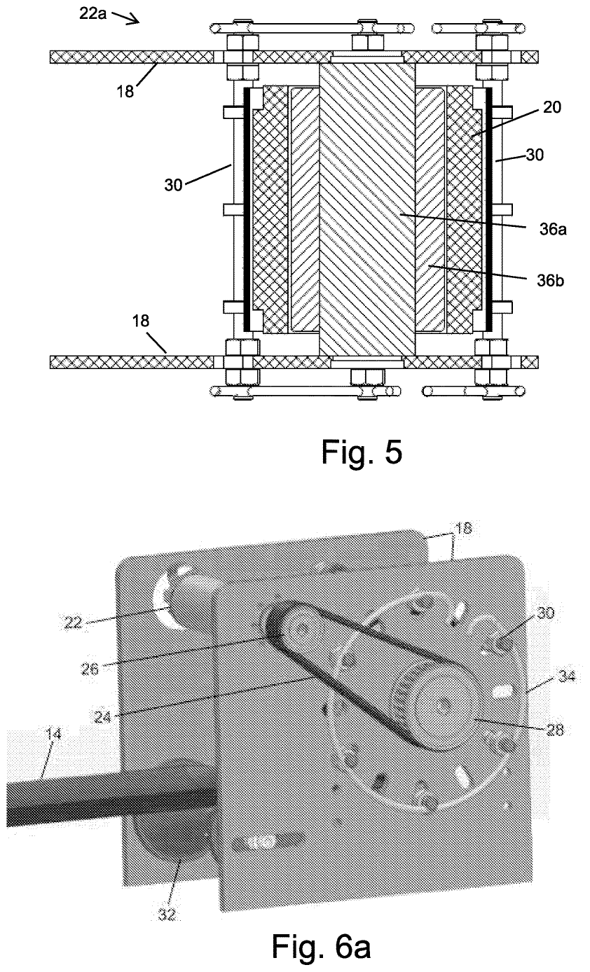

FIG. 5 symbolical shows a cross section of a frameless electric motor 22a, which replaces external motor 22 in an alternate embodiment of the drum sub-assembly 12. The stator of frameless motor 22 is fixed to walls 18 of the framework of drum sub-assembly 12. The stator of motor 22a is comprised of motor core 36a around which are the windings of the motor and motor poles 36b of the permanent magnets. Drum 20 is the rotor of the motor, which revolves around the stator. Also seen in FIG. 5 are roller sub-assemblies 30.

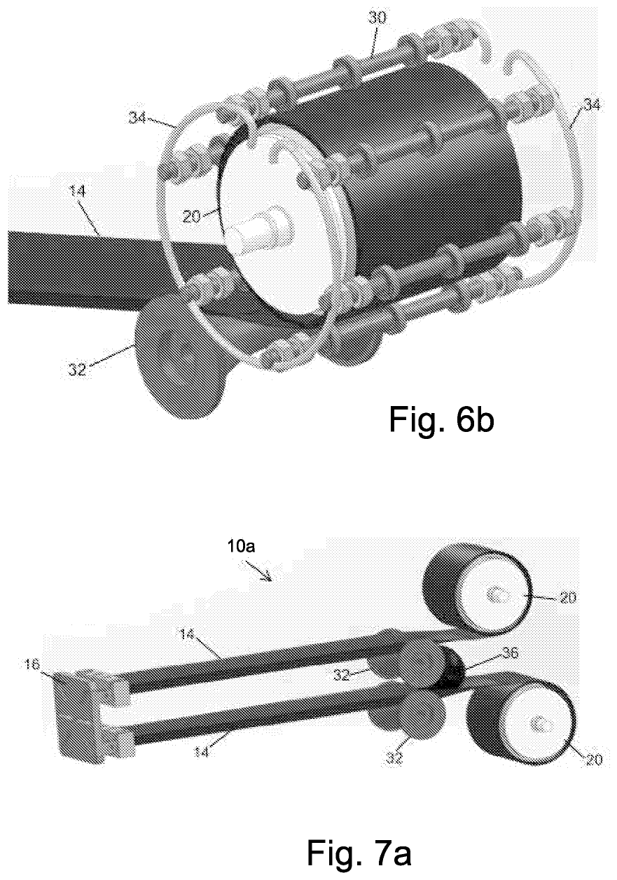

In an embodiment, shown in FIG. 6a, a spring 34 is stretched over both ends of all of the shafts of the roller sub-assemblies 30 on the outside of the walls 18 of the framework of drum sub-assembly 12. FIG. 6b shows the drum sub-assembly 12 with the walls 18 of the framework, motor 22, pulleys 26 and 28, and belt 24 removed. The springs 34 are configured to exert a force that pushes the roller sub-assemblies 30 towards the center of the drum 20. This inward force causes the rollers to maintain contact with the arm 14 as the number of coils wrapped onto drum 20 increases or decreases. This prevents backlash and insures smooth extension and retraction of arm 14.

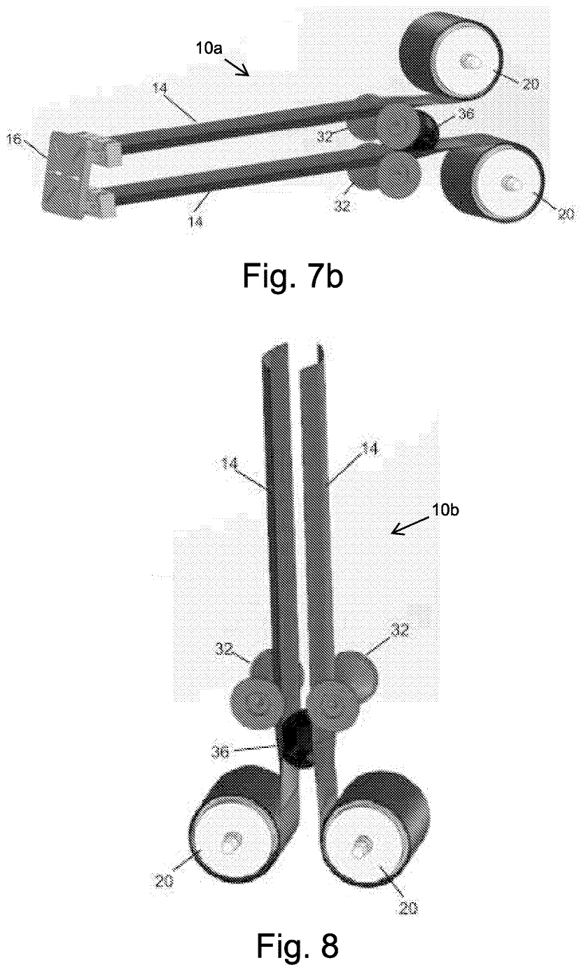

FIG. 7a shows the basic components of an embodiment of an arm assembly 10a. This embodiment is comprised of two arm assemblies 10. The top assembly is identical to arm assembly 10 as illustrated in FIGS. 1 to 6b. The bottom arm assembly comprises the same components and operates in the same way as the top assembly, but the arm material is wrapped on the drum in the opposite direction The two arm assemblies 10 are mounted one above the other between the walls 18 of the framework and the ends of both arms 14 are attached to a common end effector 16. The element labelled 36 located between support rollers 32 and drums 20 is a shaping roller, which supports the natural concave shape of the arm. Roller 36 is added to create tension against rollers 32 and make the arms 14 more rigid and vibrate less. In this embodiment the concave surfaces of both arms 14 are oriented to face in the upward direction.

This embodiment in which the upward facing surface of each arm 14 is concave forms a beam, This configuration, which provides more strength to resist bending the arm than can be -10 provided to a single arm 14 allowing the arm assembly 10a to be extended to longer distances and/or to support more weight than single arm assembly 10. It is noted that, on the same principle as that shown in FIG. 7a, arm assemblies comprised of three or more arm assemblies 10 can be constructed.

FIG. 7b illustrates how the angle of the end effector 16 of the embodiment of FIG. 7a can be changed relative to the fronts of the drum sub-assemblies by activating the two arm assemblies to unwind different lengths of their respective arms 14.

FIG. 8 shows an embodiment of an arm assembly 10b comprised of two arm assemblies 10 that are configured to raise or lower an object attached to its end effector vertically. This embodiment could be used, for example by security forces to use a camera attached to the end effector to obtain images through a window of a building or over a fence. Arm assembly 10b is identical to the arm assembly 10a shown in FIGS. 7a and 7b that has been rotated by ninety degrees with one exception. In FIG. 8 end effector 16 is not shown in order to illustrate that the two arms 14 are wound on their respective drums 20 such that when extended, their concave surfaces are oriented to face each other to provide high stability by preventing bending in either direction from the vertical.

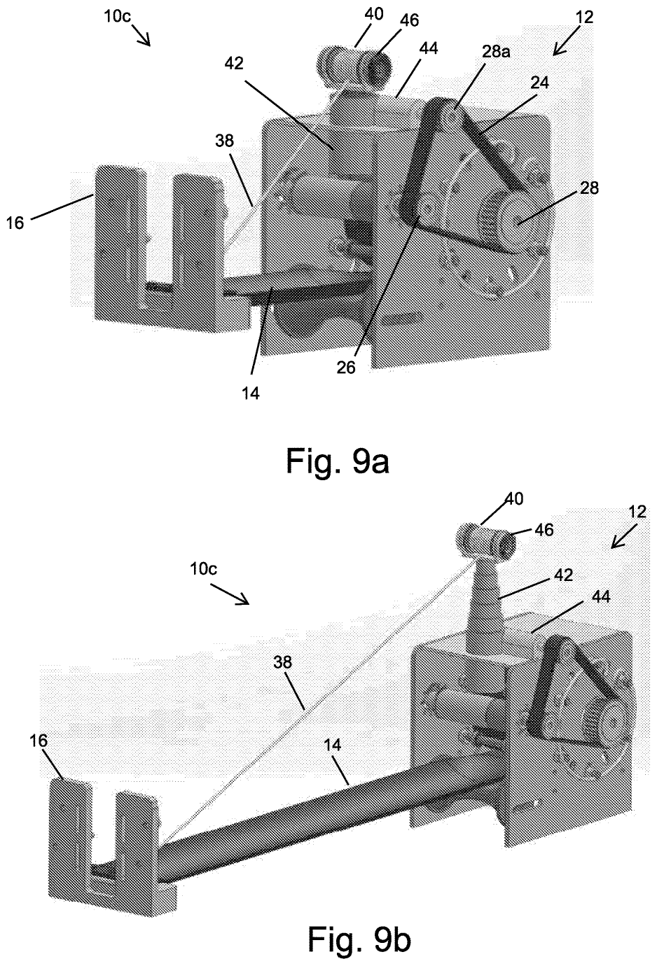

FIGS. 9a and 9b schematically show an embodiment of an arm assembly 10c, which provides support to resist bending of the arm 14 of arm assembly 10 allowing arm 14 to be extended horizontally to longer distances and/or to support more weight. Arm assembly 10c comprises a cable 38 attached at one end to the end effector 16 and at the other end is wrapped around a cable drum 40, which is mounted at the top of cable post 42 that projects out of the top of drum sub-assembly 12.

On both sides of cable drum 40 are springs 46 that provide tension on cable 38 allowing it to be unwound from cable drum 40 as arm 14 is extended from drum sub-assembly 12 and to wind cable 38 back onto cable drum 40 as arm 14 is pulled back into drum sub-assembly 12. Simultaneously with the changes in length of the arm extended from drum sub-assembly 12 and the consequent changes of length of cable 38 unwound from cable drum 40, the height of cable post 42 changes, as schematically illustrated by comparing FIG. 9a with FIG. 9b. The purpose of changing the height of cable post 42 is to maintain a geometrical supportive triangle between the cable 38 and the arm 14.

Increasing and decreasing the height of cable post 42 is accomplished by means of post height adjustment mechanism 44, which can be any type of mechanical system known in the art, e.g. pneumatic, hydraulic, or geared. In the embodiment shown, post height adjustment mechanism 44 is activated by motor 22 of drum sub-assembly 12, via belt 24, which interconnects a first pulley 26 on the output shaft of motor 22, a second pulley 28 on an axle of drum 20, and a third pulley 28a on an input shaft to post height adjustment mechanism 44. This arrangement also synchronizes the lengthening and shortening of cable post 42 with the extension and retraction of arm 14 from drum 20 in drum sub-assembly 12.

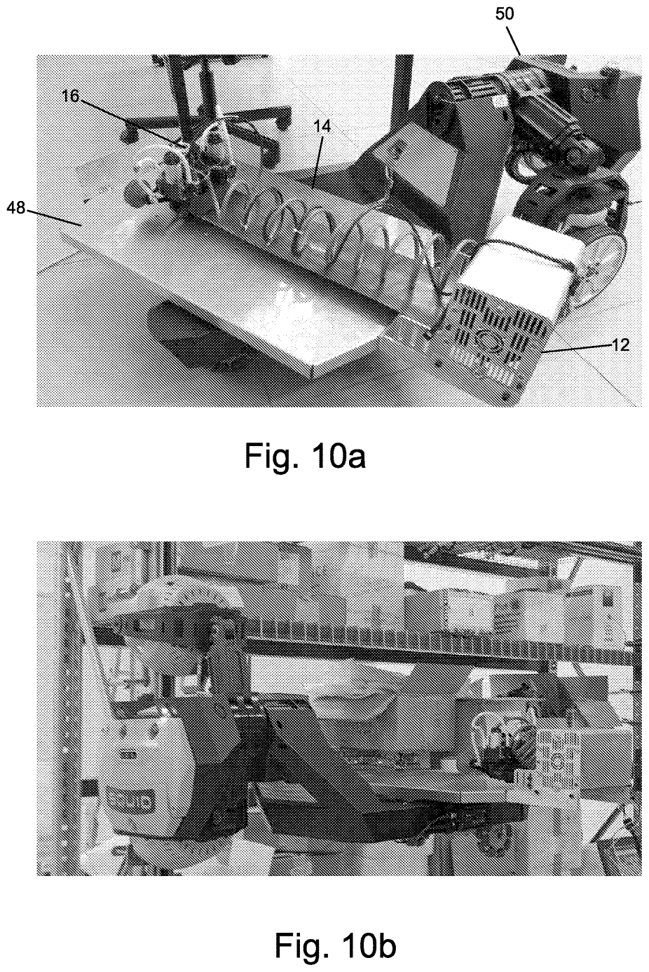

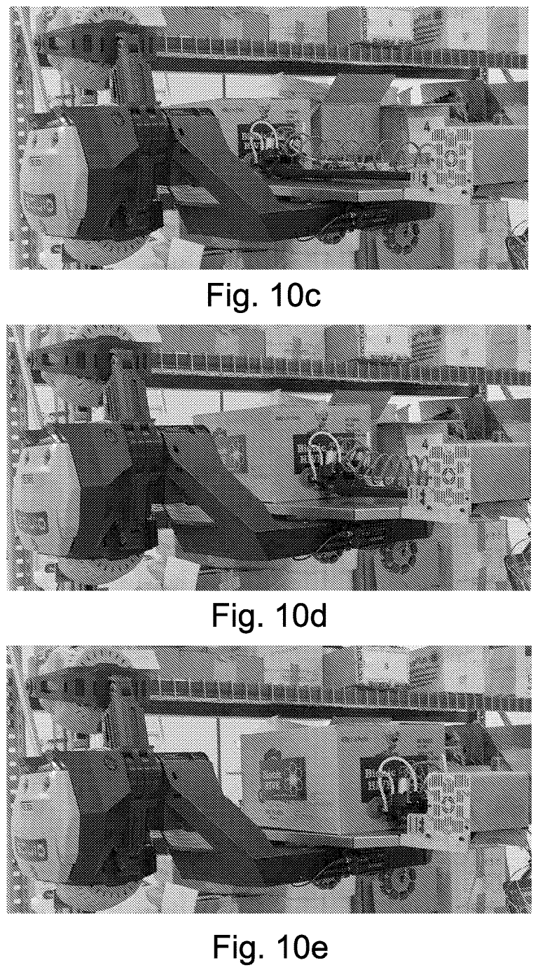

FIGS. 10a to 10d are photographs showing a scenario in which the arm assembly 10 described herein is employed. In this application, the arm assembly is mounted on one of the autonomous mobile robots described in the previously cited U.S. Pat. No. 10,259,649. Briefly these robots are designed for use in warehouses and similar facilities. The robots are capable of autonomously navigating within the warehouse to pick and place items at any designated location. Particularly unique to the robots is their ability to cling to and travel on vertical and horizontal rails of a shelving system to place or remove designated containers on shelves. A complete description of the robot can be found in U.S. Pat. No. 10,259,649 and no further details will be included herein since they are not relevant to the present invention.

FIG. 10a shows drum sub-assembly 12 attached to a tray 48 of autonomous robot 50. Robot 50 is shown on the floor of the warehouse. Arm 14 is shown extended out from drum sub-assembly 12. In this embodiment end effector 16 is equipped with pneumatically activated suction grippers.

In FIG. 10b the robot is shown climbing a vertical rail to reach the shelf on which a carton is located that the robot has been tasked to remove from the shelf and transport to another location. During this stage the arm is completely withdrawn into the housing of the drum sub-assembly as it normally would be when travelling on the floor.

In FIG, 10c, the front drive wheels have engaged horizontal rails above and below the shelf on which the carton to be picked is located. The robot has travelled until its tray is lined up with the bottom of the carton, the arm of the arm assembly is extended, and the suction gripper activated to latch onto the designated carton.

In FIG. 10d the arm is being retracted into the drum sub-assembly dragging the carton onto the tray of the robot.

In FIG. 10e the carton has been removed from the shelf and is held securely on the tray of the robot by the suction gripper of the end effector. The robot now either retraces its steps or determines a more efficient route back to the floor of the warehouse and travels with the carton aboard to the designated delivery location.

The embodiments of arm assemblies described herein provide all capabilities of other commercially available extendible robotic arms and have the following advantages: 1) they are very compact when the arms are retracted onto the drums; 2) are relatively uncomplicated mechanically; and 3) easier and less expensive to manufacture and maintain.

Although embodiments of the invention have been described by way of illustration, it will be understood that the invention may be carried out with many variations, modifications, and adaptations, without exceeding the scope of the claims.

1. An extendible mechanical arm assembly comprising: an arm comprised of a strip of resilient metal and a drum sub-assembly comprising a drum and a reversible motor: wherein, the arm has a first end that is attached to the drum and a second end and the reversible motor is configured to rotate the drum in one direction to wind the arm around the drum thereby retracting the arm towards the drum sub-assembly, and the reversible motor is configured to rotate the drum in a second, opposite direction thereby unwinding the arm from the drum and extending the second end of the arm away from the drum sub-assembly.

2. The extendible mechanical arm assembly of claim 1 wherein the arm comprises an end effector attached to the second end of the arm; wherein, the end effector is configured to allow mounting at the end of the arm any tools that are required for allowing a system to which the extendible mechanical arm assembly is attached to carry out its assigned task.

3. The extendible mechanical arm assembly of claim 2 wherein the tools are at least one of:
cameras, suction grippers, mechanical grippers, wrenches, lasers, ultrasound transducers, and barcode or QR code readers.

4. The extendible mechanical arm assembly of claim 1 wherein the drum sub-assembly is configured to be mounted on a stationary or mobile platform of any type of mechanical system that requires the use of an extendable arm.

5. The extendible mechanical arm assembly of claim 4 wherein the mechanical system is one of: a stationary robot, a mobile robot, and an autonomous mobile robot.

6. The extendible mechanical arm assembly of claim 2 wherein the drum sub-assembly is mounted on a base, which is configured to elevate, tilt, or rotate the drum sub-assembly, thereby allowing the end effector to be moved to and between any desired locations in three dimensional space around drum sub-assembly within a maximum radius determined by the length of arm.

7. The extendible mechanical arm assembly of claim 1 wherein the arm is comprised of a strip of high yield spring steel.

8. The extendible mechanical arm assembly of claim 1 wherein the arm in its extended state has a concave cross section.

9. The extendible mechanical arm assembly of claim 8 wherein the cross section of the arm is forced to be flat when it is wound onto the drum and the material of which the arm is made is resilient enabling the cross section to returns to its concave shape when the arm is unwound from the drum and returned to its extended state.

10. The extendible mechanical arm assembly of claim 1 wherein components of the drum sub-assembly are enclosed in and supported by a framework.

11. The extendible mechanical arm assembly of claim 1 wherein the framework comprises at least two walls facing each other on opposite sides of the drum sub-assembly.

12. The extendible mechanical arm assembly of claim 11 wherein the reversible electric motor is one of:
a) an external motor that transfers force from an output shaft of the motor to an axle of the drum by means of a mechanical connection: and
b) a frameless electric motor, wherein the stator of the frameless motor, which is fixed to the walls of the framework of the drum sub-assembly, is comprised of a motor core around which are windings of the motor and motor poles of the permanent magnets and the drum acts as the rotor of the motor, which revolves around the stator.

13. The extendible mechanical arm assembly of claim 1 wherein the drum sub-assembly comprises a support roller configured to support and guide the arm as it is coiled onto and uncoiled from the drum.

14. The extendible mechanical arm assembly of claim 1 wherein the drum sub-assembly comprises several roller assemblies configured to keep incoming and outgoing portions of the arm firmly pressed against other portions of the arm that are coiled on the drum as the arm is retracted or extended.

15. The extendible mechanical arm assembly of claim 14 wherein each of the roller assemblies comprises a shaft that attached to the frame so that the shaft cannot rotate and several spaced apart rollers are attached to the shaft via ball bearings.

16. The extendible mechanical arm assembly of claim 15 wherein the roller assemblies comprise a spring stretched over both ends of the shafts of the roller sub-assemblies on the outside of the walls of the framework; wherein the spring is configured to exert a force that pushes the roller sub-assemblies towards the center of the drum.

17. An extendible mechanical arm assembly of claim 1 comprising two drum sub-assemblies and associated arms; wherein the two drum sub-assemblies are mounted one above the other between the walls of the framework and the ends of both arms are attached to a common end effector.

18. The extendible mechanical arm assembly of claim 17 comprising a shaping roller between the support rollers and drums of the two drum sub-assemblies, wherein the shaping roller is configured to support the natural concave shape of the arms, to create tension against the support rollers and make the arms more rigid and vibrate less.

19. The extendible mechanical arm assembly of claim 18 wherein, in their extended states, the concave surfaces of both arms are oriented in one of the following ways:
a) facing in an upwards direction; thereby creating a beam-like structure for moving items horizontally; and
b) facing each other; thereby creating a beam-like structure suitable for moving items vertically.

20. The extendible mechanical arm assembly of claim 19 wherein the angle of the end effector relative to a vertical plane is changed by activating the two arm assemblies to unwind different lengths of their respective arms.

21. The extendible mechanical arm assembly of claim 1, comprising a cable, a cable drum, an extendible cable post, and a cable post height adjustment mechanism; wherein:
a) a first end of the cable is attached to the cable drum and a second end of the cable is attached to an end effector at the second end of the arm;
b) the cable drum is mounted at the top of the cable post;
c) the cable post projects out of the top of the drum sub-assembly;
d) the height of the cable post is changed by activation of the cable post height adjustment mechanism;
e) the length of the cable unwound from or wound back onto the drum is changed as the arm is extended of retracted;
f) the cable post height adjustment mechanism comprises a belt configured to transfer rotation of a first pulley on the output shaft of the electric motor of the drum sub-assembly to the rotation of a second pulley on an axle of the drum of the drum sub-assembly and a third pulley on an input shaft to the cable post height adjustment mechanism, thereby changing the height of the cable post in synchronization with changes in the length of the arm; and
g) springs on both sides of cable drum configured to provide tension on the cable, thereby allowing it to be unwound from the cable drum as the arm is extended and to wind the cable back onto the cable drum as the arm is pulled back into the drum sub-assembly.
